(19) United States
(12) Patent Application Publication
(10) Pub. No.: US 2013/0122260 A1
(43) Pub. Date: May 16, 2013

(54) GLASS SUBSTRATE HAVING A PATTERNED LAYER OF COMPRESSIVE STRESS ON A SURFACE THEREOF

(71) Applicant: NAI-YUE LIANG, Taipei (TW)

(72) Inventor: NAI-YUE LIANG, Taipei (TW)

(21) Appl. No.: 13/293,134

(22) Filed: Nov. 10, 2011

(51) Int. Cl. B32B 7/02; B32B 3/30; B32B 3/10

(52) U.S. Cl. 428/172; 428/195.1

(57) ABSTRACT

A glass substrate having a patterned layer of compressive stress on a surface thereof includes a patterned layer of compressive stress on at least one surface thereof. The patterned layer has a plurality of area of different surface compressive stress. The patterned layer includes high stress areas separated by a low stress area. The surface compressive stress difference between the areas is larger than 100 MPa, or the depth difference of the areas is larger than 5 μm. The depth of compressive stressed layer is less than 20 μm, and the compressive stress is lower than 400 MPa. The depth of compressive stressed layer is between 5 μm to 90 μm, and the compressive stress is between 100 MPa to 800 MPa. The strength of glass substrate in the high stress area will be improved, and the low stress area of the glass substrate still remains well capability for performing cutting, splitting, or grinding.

### FIELD OF THE INVENTION

The present invention relates to tempered glass substrate, and particular to a tempered glass substrate having non-tempered area for performing extra works such as cutting or splitting.

### DESCRIPTION OF THE PRIOR ART

Tempered glass is a pre-stressed glass. Common processes for making tempered glass are thermal tempering process and chemical process. Thermal tempering process is done by heating the glass between the strain point and softening point. The glass is then rapidly cooled below the strain point so as to create a surface layer retaining compressive stress for improving strength of the glass substrate. The chemical process is done by ion exchange through soaking a glass substrate (such as sodium glass substrate) into a liquid (such as molten sylvite) for tempering process so that larger ions (potassium ions) will take the place of the small ions (sodium ions). Such exchange will retain compressive stress into the surface of the substrate for increasing toughness against tensile force. However, both the processes will toughen the whole glass substrate. The stress retained inside the substrate will increase the difficulty of extra working to the tempered glass such as cutting or splitting. For the tempered glass with the depth of stressed layer over 20 μm and compressive stress over 400 MPa, the flaws caused by the machinery will easily result in shattering. Even the tempered glass is successfully cut, the edge won't be very smooth especially for thick glass substrate. Accordingly, all the work such as cutting, drilling, and polishing must be done before the tempering process. Such limitation seriously constrains the usage of tempered glass substrate among various panel applications. For example, the manufacture of the panel using tempered glass has to be done unit by unit. The glass has to be cut into pieces according to the specification in advanced, and the circuit layout and related processes can be performed to the pieces. The productivity is then extremely lowered. For the complicated and precise processes of panel manufacturing, such limitation will cause more difficulties and defects to the product.

### SUMMARY OF THE PRESENT INVENTION

Accordingly, the primary object of the present invention is to provide a glass substrate having a patterned layer of compressive stress to form predetermined tempered area and non-tempered area on a surface thereof. The tempered area will improve strength of the glass substrate against splintering and scratching. However, extra work to the glass substrate such as cutting, splitting, and grinding can be performed through the non-tempered area of the glass substrate.

The various objects and advantages of the present invention will be more readily understood from the following detailed description when read in conjunction with the appended drawing.

### BRIEF DESCRIPTION OF THE DRAWINGS

FIG. 1 is a schematic view of the present invention.

FIG. 2 is a cross-section view of the present invention.

FIG. 3 is a cross-section view showing another embodiment of the present invention.

FIG. 4 is a schematic view of a yet embodiment of the present invention; and

FIG. 5 is a cross-section view showing the yet embodiment of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

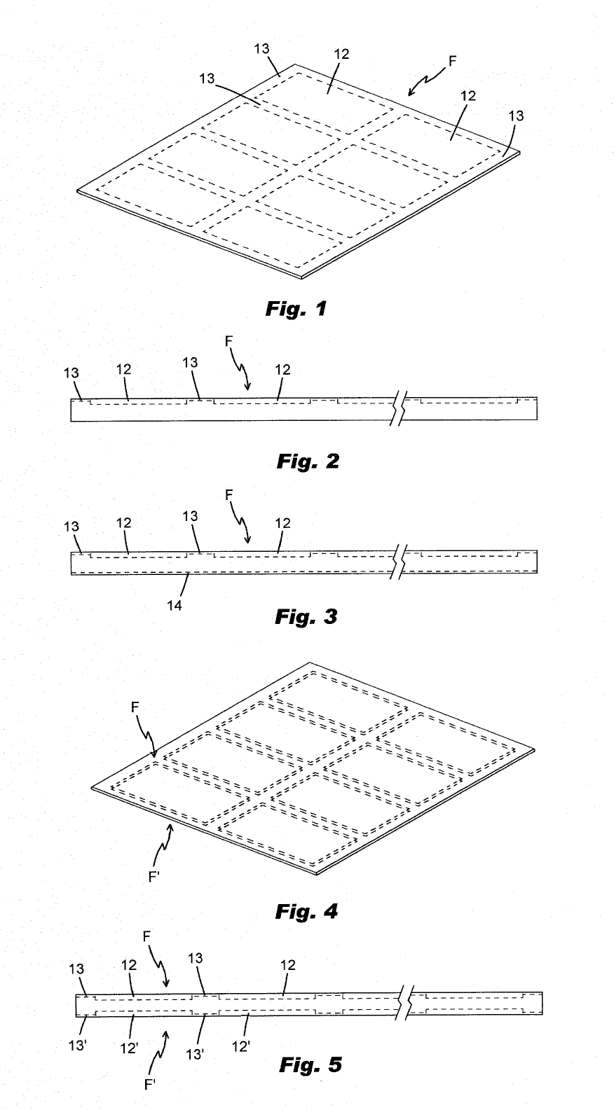

Referring to FIGS. 1 and 2, a compressive stress pattern F is formed to an upper surface of a glass substrate by chemical process. The compressive stress pattern F includes a plurality of high stress area 12 separated by low stress areas 13 so that the high stress area 12 (regarded as tempered area) of strength and low stress area 13 (regarded as non-tempered area) reserved for cutting, splitting, or grinding are formed to the surface of the glass substrate.

Preferably, the glass substrate is a flat sodium glass with a thickness of 1 mm. The glass substrate is soaked by molten sylvite for forming a predetermined pattern of compressive stress area so that the area within the pattern is tempered and the rest area of the glass substrate still has capability of being worked. Wherein, the depth of compressive stress layer of the low stress area 13 is less than 20 μm, and the compressive stress is lower than 400 MPa. The depth of compressive stress layer of the high stress area 12 is between 5 μm to 90 μm, and the compressive stress is between 100 MPa to 800 MPa. In the embodiment mentioned above, the surface of the glass substrate is separated into high stress areas 12 and low stress areas 13. The stress difference between adjacent areas is larger than 100 MPa, or the depth difference between adjacent areas is larger than 5 μm.

Comparing with known processes of making tempered glass, the tempered glass substrate of the present invention still can be cut, split, or ground. For example, the glass substrate of the present invention can be used for panel production by forming circuit or component within the high stress area and performing extra work within low stress area so that the process limitation of the tempered glass can be eliminated and the yield, productivity can be also improved.

Comprehensibly, the compressive stress pattern F is formed to the upper surface of the substrate and the opposite lower surface can have a compressive stress layer 14 retaining even stress so as to prevent deformation to glass substrate due to stress difference as shown in FIG. 3. The compressive stress layer 14 is similar to the low stress area 13 with the depth of the compressive stress layer 14 is less than 20 μm, and the compressive stress is lower than 400 MPa.

Referring to FIGS. 4 and 5, another embodiment of the present invention is illustrated. Compressive stress patterns F and F′ are formed to both the upper and lower surfaces of the glass substrate, and the patterns on both surfaces are symmetric. The high stress areas 12 and 12′ of the upper surface and the lower surface respectively are matched, the low stress area 13 and 13′ of the upper surface and the lower surface respectively are matched. The compressive stresses on both surfaces of the glass substrate are balanced so as to prevent deformation. The strength of glass substrate in high stress area will be double improved in the present invention, and the low stress area still remains well capability for extra work.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A glass substrate having a patterned layer of compressive stress on a surface thereof comprising a patterned layer retaining compressive stress on at least one surface thereof; the patterned layer of compressive stress having a plurality of areas including high stress areas and low stress areas retaining different compressive stresses; the high stress areas being separated by lower stress areas; the surface compressive stress difference between areas being larger than 100 MPa; and
wherein the surface compressive stress retained in the low stress area is less than 400 MPa; and
the surface compressive stress retained in the high stress area is between 100 MPa to 800 MPa.

2-3. (canceled)

4. A glass substrate having a patterned layer of compressive stress on a surface thereof comprising a patterned layer retaining compressive stress on at least one surface thereof; the patterned layer of compressive stress having a plurality of high stress area separated by lower stress area; the high stress area and the low stress area having different depths of the layer of compressive stress, and the depth difference between the high stress area and the low stress area being larger than 5 μm; and
wherein the depth of the layer of compressive stress of the low stress area is less than 20 μm; and
wherein the depth of the layer of compressive stress of the high stress area is between 5 μm to 90 μm.

5-6. (canceled)

7. The glass substrate having a patterned layer of compressive stress on a surface thereof as claimed in claim 4, wherein at least one of the upper surface or lower surface of the glass substrate is a flat surface; the opposite surface of the flat surface is one of a flat surface or uneven surface.

8. The glass substrate having a patterned layer of compressive stress on a surface thereof as claimed in claim 7, wherein the upper and lower surfaces of the glass substrate are flat surfaces and the thickness of the glass substrate is less than 5 mm.

9. The glass substrate having a patterned layer of compressive stress on a surface thereof as claimed in claim 4, wherein the glass substrate is made of one of soda-lime glass or aluminosilcate glass.

10. The glass substrate having a patterned layer of compressive stress on a surface thereof as claimed in claim 4, wherein a layer of even compressive stress is formed to the opposite lower surface of the glass substrate.

11. The glass substrate having a patterned layer of compressive stress on a surface thereof as claimed in claim 10, wherein the surface compressive stress of the layer of even compressive stress is less than 400 MPa.

12. The glass substrate having a patterned layer of compressive stress on a surface thereof as claimed in claim 10, wherein the depth of the layer of even compressive stress is less than 20 μm.

13. The glass substrate having a patterned layer of compressive stress on a surface thereof as claimed in claim 4, wherein both the upper and lower surface of the glass substrate have a patterned layer of compressive stress.

14. The glass substrate having a patterned layer of compressive stress on a surface thereof as claimed in claim 13, wherein the patterned layers on the upper and lower surfaces of the glass substrate are matched.
